(19) United States
(12) Patent Application Publication
(10) Pub. No.: US 2010/0039997 A1
(43) Pub. Date: Feb. 18, 2010

(54) METHOD AND APPARATUS FOR IMPLIED RESOURCE ASSIGNMENT FOR UPLINK ACKNOWLEDGMENT SIGNALLING

(75) Inventors: Rapeepat Ratasuk, Hoffman Estates, IL (US); Amitabha Ghosh, Buffalo Grove, IL (US); Robert T. Love, Barrington, IL (US); Weimin Xiao, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/191,942

(22) Filed: Aug. 14, 2008

(51) Int. Cl. H04W 4/00

(52) U.S. Cl. 370/329

(57) ABSTRACT

A network node constructs (22) a downlink transmission using at least one group of resource elements. A remote unit receives (12) the downlink transmission and determines (13) a lowest index of the at least one group of resource elements. The remote unit then determines (14) an uplink resource, for use in uplink (UL) acknowledgment signaling, using the lowest index. The network node then receives (23, 24) the UL acknowledgment signaling that corresponds to the downlink transmission, the UL acknowledgment signaling having been transmitted using the uplink resource based on the lowest index. To determine the uplink resource, both the remote unit and the network node implicitly use the lowest index of the at least one group of resource elements that were used to construct the downlink transmission. Implicitly determining the uplink resource in this manner, serves to reduce overhead related to acknowledgment signaling.

### FIELD OF THE INVENTION

The present invention relates generally to data communication and, in particular, to implied resource assignment for uplink (UL) acknowledgment signaling.

### BACKGROUND OF THE INVENTION

In wireless interfaces such as those based on the evolving 3GPP LTE (Long Term Evolution) interface, overhead signaling can consume a substantial portion of the total signaling capacity of the interface. Thus, ongoing standards work often focuses on techniques to minimize this overhead. For example, in prior 3GPP LTE standards work, it has been agreed that UL (uplink) ACK/NACK assignment is to be implicitly associated with the control channel element (CCE) index used for the downlink scheduling grant. Additional techniques further able to reduce the overhead associated with the downlink grant and UL ACK/NACK are therefore desirable.

### BRIEF DESCRIPTION OF THE DRAWINGS

FIG. 1 is a logic flow diagram of functionality performed by a remote unit in accordance with multiple embodiments of the present invention.

FIG. 2 is a logic flow diagram of functionality performed by a network node in accordance with multiple embodiments of the present invention.

FIG. 3 is a block diagram depiction of a wireless communication system in accordance with multiple embodiments of the present invention.

FIG. 4 is a block diagram depiction of a tree structure used to map control channel elements (CCEs) to control channels, in accordance with certain embodiments of the present invention.

FIG. 5 is a block diagram depiction of an implicit mapping between control channel elements (CCEs) to UL ACK/NACK indexes, in accordance with certain embodiments of the present invention.

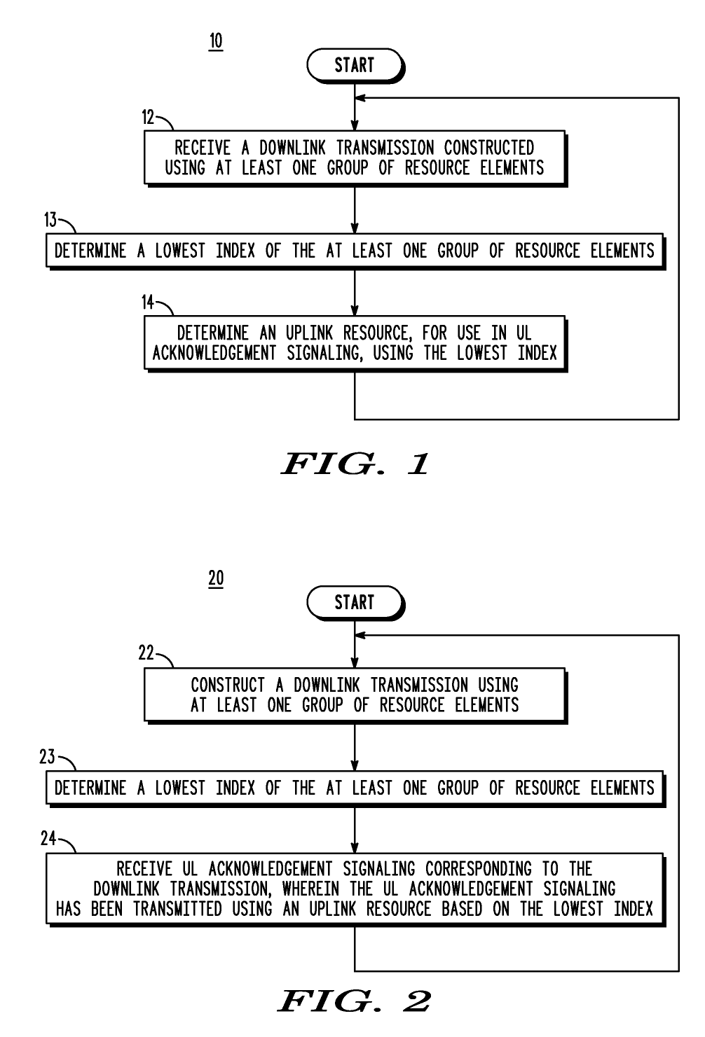

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments of implied resource assignment for UL acknowledgment signaling are described. Logic flow diagrams 10 and 20, in FIGS. 1 and 2, depict functionality performed in accordance with multiple embodiments of the present invention. A network node constructs (22) a downlink transmission using at least one group of resource elements. A remote unit receives (12) the downlink transmission and determines (13) a lowest index of the at least one group of resource elements. The remote unit then determines (14) an uplink resource, for use in uplink (UL) acknowledgment signaling, using the lowest index. The network node then receives (23, 24) the UL acknowledgment signaling that corresponds to the downlink transmission, the UL acknowledgment signaling having been transmitted using the uplink resource based on the lowest index. To determine the uplink resource, both the remote unit and the network node implicitly use the lowest index of the at least one group of resource elements that were used to construct the downlink transmission. Implicitly determining the uplink resource in this manner, serves to reduce overhead related to acknowledgment signaling.

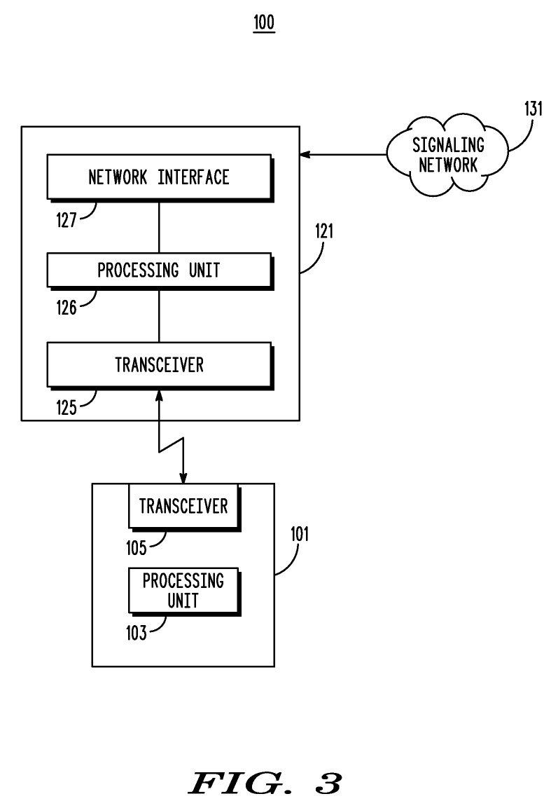

The disclosed embodiments can be more fully understood with reference now to FIGS. 3-5. FIG. 3 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the 3GPP technologies such as LTE, suitably modified to implement the present invention. Alternative embodiments of the present invention may be implemented in communication systems that employ other or additional technologies such as, but not limited to, those described in the OMA, IEEE 802, WiMAX Forum, and/or 3GPP2 specifications.

Communication system 100 is depicted in a very generalized manner. For example, system 100 is shown to simply include remote unit 101, network node 121 and signaling network 131. Network node 121 is shown having interconnectivity via signaling network 131. Network node 121 is shown providing network service to remote unit 101 using wireless interface 111. The wireless interface used is in accordance with the particular access technology supported by network node 121, such as one based on 3GPP LTE. Those skilled in the art will recognize that FIG. 3 does not depict all of the physical fixed network components that may be necessary for system 100 to operate but only those system components and logical entities particularly relevant to the description of embodiments herein.

As depicted in FIG. 3, network node 121 comprises a processing unit 126, a network interface 127 and a transceiver 125. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, device 121 represents a known device that has been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Remote unit 101 and network node 121 are shown communicating via technology-dependent, wireless interface 111. Remote units, subscriber stations (SSs) and/or user equipment (UEs), may be thought of as mobile stations (MSs), mobile subscriber stations (MSSs), mobile devices or mobile nodes (MNs). In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 101 comprises a processing unit (103) and transceiver (105). Depending on the embodiment, remote unit 101 may additionally comprise a keypad (not shown), a speaker (not shown), a microphone (not shown), and a display (not shown). Processing units, transceivers, keypads, speakers, microphones, and displays as used in remote units are all well-known in the art.

Operation of embodiments in accordance with the present invention occurs substantially as follows, first with reference to FIG. 3. As depicted in FIG. 3, network node 121 is a current serving node for remote unit 101. Network node processing unit 126 constructs a downlink transmission using at least one group of resource elements. Depending on the embodiment, resource elements may correspond to sub-carriers, for example. Also depending on the embodiment, a group of resource elements may correspond to a control channel element (CCE).

Remote unit processing unit 103 then receives via transceiver 105 this downlink transmission. The downlink transmission may in some embodiments be a downlink control channel transmission or in others a downlink resource block transmission. Processing unit 103 determines a lowest index of the at least one group of resource elements to determine an uplink resource for use in signaling an ACK/NACK corresponding to the downlink transmission. For example, processing unit 103 may use the determined lowest index to in turn determine the uplink index to use in transmitting the ACK/NACK. Network node processing unit 126 also determines the lowest index of the at least one group of resource elements to determine the uplink resource that will be used by remote unit 101 to ACK/NACK the downlink transmission.

Although the term “lowest” is used herein to refer to the index that is used, “lowest” may refer to any designated index that is implicitly used by both the network node and the remote unit. For example, a first index, a second index, a third index, a last index, a second to last index, etc. may be selected as the “lowest.” To determine the uplink resource, both the remote unit and the network node implicitly use the same index of the at least one group of resource elements that were used to construct the downlink transmission. Implicitly determining the uplink resource in this manner, serves to reduce overhead related to acknowledgment signaling.

Reference has been made to LTE embodiments above. Therefore, a summary that focuses on certain LTE embodiments appears below to provide some additional and more particular examples. They are intended to further the reader's understanding of the variety of possible embodiments rather than to limit the scope of the invention.

In the LTE uplink as it presently exists, a fixed number of acknowledgements are reserved for explicit assignment to persistently scheduled UEs. A variable number of acknowledgements are required based on the possible number of CCEs used in downlink scheduling (i.e., based on the number of OFDM symbols used for control). The actual amount of ACK/NACK resource utilized obviously depends on the number of acknowledgements that can be accommodated in one control resource. This in turn depends on system deployment parameters such as cyclic prefix length and whether the system is FDD or TDD. In addition, high mobility may also reduce the number of possible acknowledgements under some scenarios.

In general, to transmit the ACK/NACK the UE needs to know (1) the control resource which is mapped to two resource blocks, (2) the frequency domain CAZAC (Constant Amplitude Zero Auto-Correlation) sequence and cyclic shift value, and (3) the time domain orthogonal spreading sequence and index. Naturally, the available CAZAC sequences and time-domain orthogonal spreading sequences are known to the UE beforehand. Thus, when a UE is given a downlink scheduling grant, the UE needs to figure out the control resource, cyclic shift, and time-domain spreading sequence index to use according to some rules. Note that orthogonality between different time-domain codes is dependent on the Doppler spread, while orthogonality between different cyclic shifts is dependent on the channel spread. With regard to implicit mapping, several recommendations may be made as follows:

ULACK/NACK Index is Implicitly Mapped from the Lowest CCE Index

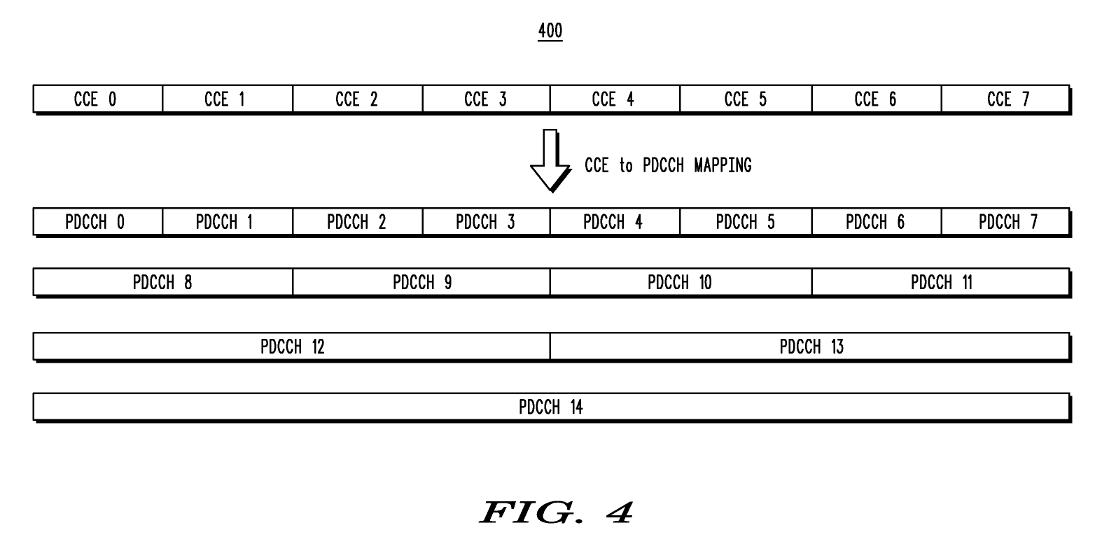

In order to reduce the number of blind decodings by the UE, it was agreed to construct a control channel (CCH) from 1, 2, 4, or 8 CCEs using tree structure 400 as shown in FIG. 4. To reduce the number of acknowledgements required, the ACK/NACK index may be implicitly tied to the lowest CCE index used to construct the PDCCH. For example, from FIG. 4 it is seen that PDCCH 13 is construct from CCE 4-7. As a result, the implicit ACK/NACK for any UE scheduled using this CCH will be tied to CCE 4, if the smallest CCE index is implicitly used. As a consequence, the number of uplink acknowledgements required is equal to the number of CCEs used for downlink scheduling grant.

### Persistently Scheduled Users are Explicitly Assigned ACK/NACK Indication

Persistently scheduled users are explicitly assigned ACK/NACK indication. This could, for example, be done via higher-layer signaling as part of the persistent assignment. Note that a separate set of ACK/NACK resources should be reserved for this purpose independently of the implicit ACK/NACK resource. In addition, these resources should be allocated first.

### CCE Indices are Mapped Sequentially to Control Channel Resource

As noted previously, one control channel resource can support a certain number of acknowledgements (e.g., 18 for normal cyclic prefix). As a result, multiple control resources may be required, especially since the number of OFDM symbols used for control can vary on a sub-frame basis. As a result, CCE indices should be mapped sequentially to control channel resource so that any unused control resource can be reassigned for other purposes (see “UL ACK/NACK Resource Provisioning”, Motorola, RAN1#50, Athens, Greece, August 2007 for possible options). For example, CCE 0-17 can be mapped to control resource 0 while CCE 18-35 can be mapped to control resource 1. This way, if CCE 18-35 are not used in this sub-frame then the eNB may schedule uplink data transmission in control resource 1 in the corresponding uplink sub-frame.

Within a Control Channel Resource, CCE Indices are Mapped First by Cyclic Shift then by Spreading Sequence Index

For example, if control resource 0 can accommodate CCE 0-17, then CCE 0 is mapped to {v₁, c₁} where vᵢ is the cyclic shift index and cᵢ is the orthogonal cover, CCE 1 is mapped to {v₂, c₁}, and so on. This mapping may be beneficial when high-speed UEs transmit on adjacent ACK/NACK indices so that their orthogonality is maintained. In addition, when possible the eNB can ensure that acknowledgements from high-speed UEs do not interfere with each other by appropriate selection of the CCEs used for the downlink scheduling grants.

PDCCH Assignment should Follow a Ranking Order

Although this is an implementation issue, in general it is beneficial to order scheduled users based on their CCE requirements. In this case, due to the tree structure, users should be ranked from highest to lowest number of CCEs required. This way, the maximum number of users can be scheduled with the smallest number of uplink control channel resource. As noted earlier, reserved control channel resource may then be used for other purposes. Note that appropriate PDCCH assignment can also be used to maintain uplink ACK/NACK orthogonality for high-speed UEs.

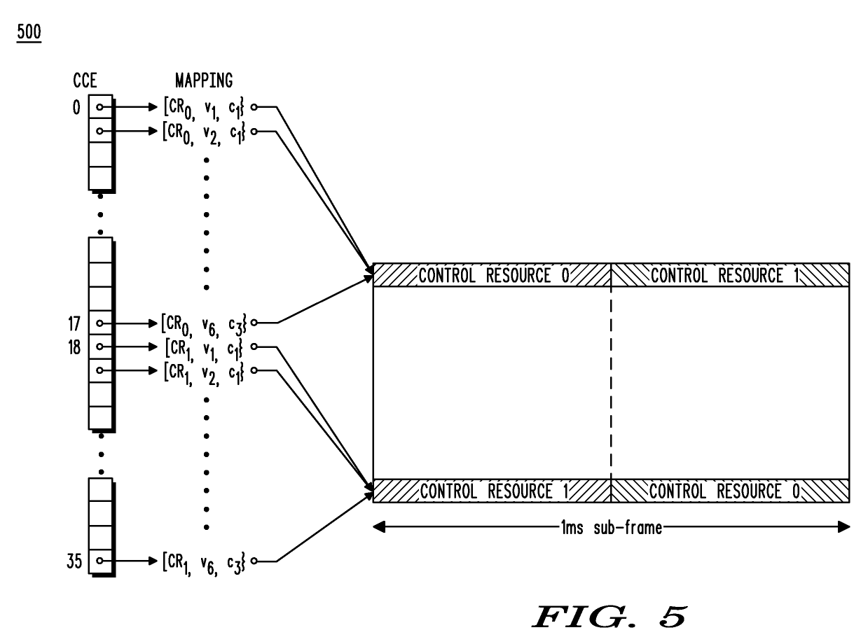

FIG. 5 is a block diagram depiction of an implicit mapping between control channel elements (CCEs) to UL ACK/NACK indexes, in accordance with certain embodiments of the present invention. Diagram 500 provides an example of the implicit mapping in which 36 CCEs are available for downlink scheduling grant assignment and one control resource can support 18 acknowledgements. In general, it is suggested that an implicit mapping scheme should be structured in such a way that a minimum amount of uplink resource is used. This way, the eNB may schedule uplink data transmission in resources reserved for control but not used.

One of skill in the art will appreciate that various modifications and changes may be made to the specific embodiments described above with respect to FIGS. 3-5 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, and the conveyance of some symbol representing the information or object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method of implied resource assignment for uplink (UL) acknowledgment signaling, the method comprising:
receiving a downlink transmission constructed using at least one group of resource elements;
determining a lowest index of the at least one group of resource elements;
determining an uplink resource, for use in uplink (UL) acknowledgment signaling, using the lowest index.

2. The method of claim 1, wherein the at least one group of resource elements comprises at least one control channel element.

3. The method of claim 1, wherein the at least one group of resource elements comprises at least one group of sub-carriers.

4. The method of claim 1, further comprising transmitting, by a remote unit, an ACK/NACK using the uplink resource.

5. The method of claim 4, wherein transmitting the ACK/NACK comprises
transmitting the ACK/NACK via an uplink control channel.

6. The method of claim 1, wherein receiving the downlink transmission comprises
receiving, by a remote unit, the downlink transmission via a downlink control channel.

7. The method of claim 1, wherein receiving the downlink transmission comprises
receiving, by a remote unit, the downlink transmission via a downlink resource block.

8. The method of claim 1, wherein the lowest index comprises a lowest control channel element (CCE) index.

9. The method of claim 1, wherein the lowest index comprises a lowest resource block index.

10. A method of implied resource assignment for uplink (UL) acknowledgment signaling, the method comprising:
constructing a downlink transmission using at least one group of resource elements;
determining a lowest index of the at least one group of resource elements;
receiving uplink (UL) acknowledgment signaling corresponding to the downlink transmission, wherein the UL acknowledgment signaling has been transmitted using an uplink resource based on the lowest index.

11. The method of claim 10, wherein the at least one group of resource elements comprises at least one control channel element.

12. The method of claim 10, wherein the at least one group of resource elements comprises at least one group of sub-carriers.

13. The method of claim 10, wherein receiving the UL acknowledgment signaling comprises
receiving an ACK/NACK from a remote unit via an uplink control channel.

14. The method of claim 10, wherein the downlink transmission comprises a downlink control channel transmission.

15. The method of claim 10, wherein the downlink transmission comprises a downlink resource block transmission.

16. The method of claim 10, wherein the lowest index comprises a lowest control channel element (CCE) index.

17. The method of claim 10, wherein the lowest index comprises a lowest resource block index.

18. A remote unit for utilizing implied resource assignment for uplink (UL) acknowledgment signaling, the communication device comprising:
a transceiver;
a processing unit, communicatively coupled to the transceiver,
adapted to receive via the transceiver a downlink transmission constructed using at least one group of resource elements,
adapted to determine a lowest index of the at least one group of resource elements, and
adapted to determine an uplink resource, for use in uplink (UL) acknowledgment signaling, using the lowest index.

19. A network node for utilizing implied resource assignment for uplink (UL) acknowledgment signaling, the communication device comprising:
a transceiver;
a processing unit, communicatively coupled to the transceiver,
adapted to construct a downlink transmission using at least one group of resource elements,
adapted to determine a lowest index of the at least one group of resource elements, and
adapted to receive via the transceiver uplink (UL) acknowledgment signaling corresponding to the downlink transmission, wherein the UL acknowledgment signaling has been transmitted using an uplink resource based on the lowest index.
